(19) United States
(12) Patent Application Publication
(10) Pub. No.: US 2023/0165287 A1
(43) Pub. Date: Jun. 1, 2023

(54) PLANT-BASED EGG ALTERNATIVE

(71) Applicant: ROQUETTE FRERES, LESTREM (FR)

(72) Inventors: Géraldine DEDIEU, Lestrem (FR); Florian SARRAZIN, Fouquereuil (FR)

(21) Appl. No.: 17/997,069

(22) PCT Filed: Apr. 29, 2021
(86) PCT No.: PCT/FR2021/050748

§ 371 Date: Oct. 25, 2022

(30) Foreign Application Priority Data
Apr. 30, 2020 (FR) FR20 04338

(51) Int. Cl. A23L 15/00; A23L 29/219; A23J 3/14; A23L 27/60

(52) U.S. Cl. CPC A23L 15/35; A23L 29/219; A23J 3/14; A23L 27/60

(57) ABSTRACT

The present invention relates to an egg substitute and to a method for the production thereof, and to the compositions comprising said egg substitute. More specifically, the present invention relates to a composition comprising a legume albumin and a pregelatinized starch.

### TECHNICAL FIELD

The present invention relates to an egg substitute and to a method for the production thereof, and to the compositions comprising said egg substitute, principally dedicated to the food sauces industry, more specifically mayonnaise.

### BACKGROUND ART

Eggs are well known foods in the food industry. The egg ingredients market has been estimated at 6 billion US dollars worldwide, and continues to grow. Eggs have a high nutritional value, and are therefore an essential component in a wide range of food products, including, but not limited to, breads, cakes, biscuits, such as muffins or scones, soufflés, pasta, sauces, pastry creams and ice cream.

However, eggs have a number of drawbacks. They contain high levels of cholesterol and saturated fats, which increases the risk of cardiovascular diseases and obesity. Other consumers want to avoid consuming egg-based products due to food allergies or other dietary restrictions. Lastly, some consumers do not want to eat eggs for religious or ethical reasons. Furthermore, the microbiological quality of the eggs is sometimes poor in a number of countries (for example in Russia).

In order to remedy these problems, agri-food research has been working on plant-based egg alternatives for many years. This alternative must be environmentally friendly and have a low allergenic response in order to be able to respond effectively to these challenges. Soya-based solutions should therefore be avoided.

Solutions such as those disclosed in patent application WO2014001016 (disclosing an emulsion containing a gelatinized starch, a legume grain albumin and a non-starch polysaccharide with a low charge density) or application WO2014001030 (disclosing an emulsion containing a gelatinized starch, a legume grain albumin and a polysaccharide thickener) exist but they use complex formulations, containing more than two compounds. Moreover, the non-starch polysaccharides that they use are a disadvantage for certain consumers who would like a simplified list of ingredients, involving the lowest possible number of compounds.

Mention may be made of patent application WO2013067453, which proposes multi-functional compositions that can be used as whole egg substitutes. In a preferred aspect, the composition taught in this document comprises (i) yellow pea flour, and (ii) a modified starch with a weight ratio ranging from 7:3 to 3:7, and wherein the composition provides the binding power, humectant power, raising agent, and/or emulsifying properties similar to an egg. In particular, examples 7, 8 and 9 of this application present a mixture of pea protein and modified starch to replace the egg yolk in mayonnaises.

In order to be effective, it is recommended to rehydrate the protein in water for up to 24 hours before use. FIG. 11 of this application illustrates the impact of this hydration. In fact, after one hour of hydration, the firmness of the mayonnaise (measured by the distance traveled using a consistometer) is similar to the mayonnaise obtained without hydration. According to this Figure, it takes at least 3 hours of hydration to begin to see a firmer texture (shorter distance). This hydration is an additional step that imposes an extra cost on users of these solutions. It is therefore a major barrier to its use and to competitive finished product costs. Furthermore, extra water is used. Finally, a waiting time in a hydrated medium continues to be a major risk of microbiological contamination in the agri-food industry.

It is to the applicant's credit to have worked to address these issues. This work has resulted in the composition according to the invention characterized in that it comprises a legume albumin, preferentially selected from a list comprising peas and faba beans, and a pregelatinized starch in a respective weight ratio comprised between 0.9:0.1 and 0.6:0.4, preferentially comprised between 0.8:0.2 and 0.7:0.3, even more preferentially 0.75:0.25. The invention also relates to the method for the production of the composition according to the invention, as well as various industrial uses thereof.

The invention will be better understood with the aid of the following description.

### SUMMARY OF THE INVENTION

The invention is firstly embodied in a composition comprising a legume albumin and a pregelatinized starch in a respective weight ratio comprised between 0.9:0.1 and 0.6:0.4, preferentially comprised between 0.8:0.2 and 0.7:0.3, even more preferentially 0.75:0.25, and not comprising any non-starch polysaccharide.

The invention also relates to a method for the production of the composition comprising the following steps:
Provision of a legume albumin,
Provision of a pregelatinized starch
Mixture of said two compounds.

Finally the invention also relates to the use of the composition comprising a legume albumin and a pregelatinized starch according to the invention, in the field of human food or animal feed.

The invention will be better understood with the aid of the following detailed description.

### DETAILED DESCRIPTION OF THE INVENTION

The invention is firstly embodied in a composition comprising a legume albumin and a pregelatinized starch in a respective weight ratio comprised between 0.9:0.1 and 0.6:0.4, preferentially comprised between 0.8:0.2 and 0.7:0.3, even more preferentially 0.75:0.25, and not comprising any non-starch polysaccharide.

“Ratio” is understood to mean the respective proportions by weight of each constituent (i.e. albumin and starch). To gain a better understanding, the ratio 1:0 means a composition comprising only albumin and the ratio 0.5:0.5 as comprising equal amounts of albumin and starch.

The use of a legume albumin, preferentially a pea or faba bean albumin, as will be exemplified below, offers a crucial competitive advantage to the food producer seeking a substitute for egg yolk. The solution disclosed in patent application WO2013/067453 is a composition comprising yellow pea flour and a modified starch with a weight ratio comprised between 7:3 and 3:7 (see paragraph 15). It is understood from examples 7 and 8 that the yellow pea flour is preferentially a yellow pea isolate with 80% protein content, most probably the globulin fraction marketed under the brand names EMPRO® or NUTRALYS®. The preferred modified starch is a pregelatinized starch. In this case, the preferred ratios are 50:50 or 59:41. FIG. 11 shows that a minimum hydration of 3 hours is necessary before a harder consistency is achieved, similar to that obtained with an egg yolk.

In the context of said product, it is clearly described that rehydration is necessary before use; paragraph 156 of this application specifying that said rehydration takes 24 hours. FIG. 11 shows that a minimum hydration of 3 hours is necessary before a harder consistency is achieved, similar to that obtained with an egg yolk.

Said rehydration in the context of our invention, which differs by the selection of a legume albumin, preferentially pea or faba bean, and by the higher protein ratio, makes it possible to obtain an identical result to egg yolk with prior rehydration of the albumin for a maximum of 15 minutes. This is a crucial advantage for the mayonnaise manufacturer for example, as a rehydration time of 3 hours or even 24 hours is both technically and financially crippling.

The term “protein” should be understood in the present application to mean the macromolecules formed from one or more polypeptide chains consisting of a sequence of amino acid residues bonded to one another by peptide bonds. In the particular context of pea proteins, the proteins are more particularly composed of globulins (approximately 50-60% of pea proteins) and albumins (20-25%). In the particular context of the present invention, “proteins” will be understood to mean pea albumins. For the purposes of the invention, the proteins are isolated from the other components of the plant source from which they are extracted, such as the starch and fibers. Preferably, “proteins” will be understood to mean protein concentrates or protein isolates with a respective protein content of at least 50% and 70% on solids.

“Albumin” is understood in the present application to mean the family of proteins that are soluble in water and moderately soluble in saline solutions. The albumins present in a mixture can be identified by electrophoresis or chromatography. A preferred method is described in the article “Peptide and protein molecular weight determination by electrophoresis using a high-molarity tris buffer system without urea.” (Fling S P, Gregerson D S, Anal. Biochem. 1986; 155:83-88). The albumins in the present invention are preferentially extracted from legumes, even more preferentially from peas or faba beans. A pea albumin of particular interest is, for example, extracted during the aqueous fractionation method of the various constituents of the pea, with elimination of fibers, starch and globulin type proteins (refer, for example, to patent applications EP1400537 and EP3614856 by the applicant).

“Leguminous plant” or “legume” will be understood in the present application to mean the family of dicotyledonous plants of the Fabales order. This is one of the largest flowering plant families, third after Orchidaceae and Asteraceae in terms of number of species. It contains approximately 765 genera, bringing together more than 19,500 species. Several leguminous plants are significant crop plants, such as soybean, beans, peas, chickpea, faba bean, groundnut, cultivated lentil, cultivated alfalfa, various clovers, broad beans, locust bean, licorice and lupin. In the present invention, leguminous plant will be more specifically understood to mean the pea or faba bean.

According to a preferred embodiment of the invention, the composition according to the invention comprises a legume albumin, the legume being selected from a list comprising the pea and faba bean, preferentially the pea.

The term “pea” is considered herein in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses). This term “pea” in the present application includes pea varieties belonging to the Pisum genus and more particularly to the species sativum and aestivum. Said mutant varieties are in particular those called “mutants r”, “mutants rb”, “mutants rug 3”, “mutants rug 4”, “mutants rug 5” and “mutants lam” as described in the article by C-L HEYDLEY et al., entitled “Developing novel pea starches”, Proceedings of the Symposium of the Industrial Biochemistry and Biotechnology Group of the Biochemical Society, 1996, pp. 77-87.

“Faba bean” is intended to mean the group of annual plants of the species Vicia faba, belonging to the group of leguminous plants of the Fabaceae family, Faboideae subfamily, Fabeae tribe. A distinction is made between Minor and Major varieties. In the present invention, wild-type varieties and those obtained by genetic engineering or varietal selection are all excellent sources.

“Pregelatinized starch” is understood in the present invention to mean a starch modified by a physical, mechanical or chemical treatment, preferentially physical, which gives it the ability to develop viscosity when it is added cold to a liquid formulation.

Within the meaning of the invention, “pregelatinized starch” refers to a starch that has been made “water-soluble”, in other words a starch having, at 20° C. and under mechanical stirring for 24 hours, a soluble fraction in demineralized water that is at least equal to 5% by weight. This soluble fraction is preferably greater than 20% by weight, or more preferentially greater than 50% by weight, or most preferentially greater than or equal to 70%. Of course, the water-soluble starch can be fully soluble in demineralized water, with the soluble fraction then being greater than 90%, and can be close to 100%.

The water-soluble starch preferably has a low water content, generally less than 10%, in particular less than 5% by weight.

Such starches usually have a degree of starch crystallinity of less than 15%, generally less than 5% and most often less than 1%, or even zero. By way of an example, the products manufactured and marketed by the Applicant under the trade name PREGEFLO® can be cited.

The pregelatinized starch also can be made up of a starch that has partially preserved its original granular form, obtained by atomization cooking, generally known as GCWS (Granular Cold Water Soluble) starch.

Pregelatinized starches are usually prepared by thermal, chemical or mechanical techniques likely to cause simple swelling, partial disintegration, or even complete solubilization of the starch granules such that they become soluble in water according to a so-called cold method, i.e. by dispersing in the water at a water temperature less than 45° C., preferentially less than 35° C. and even more preferentially close to ambient temperature, i.e. 20° C.+/−5° C.

The starch source is selected from any source currently available and including pregelatinized starches derived from corn, potato, wheat, rice, peas, oats, lentils, faba beans, broad beans, beans, chickpeas, or combinations thereof.

The preferred modification treatment involves heating the starch before drying, preferentially performed using a drying drum, atomization or even extrusion, even more preferentially by passing through a drying drum. It is known that the starch is gelatinized by breaking down the starch granules under the combined action of moisture, temperature and pressure. A pregelatinized starch has the advantage of being able to be dispersed in cold water, which enables it to be used, for example, in instant food preparations. These starches are well known in the prior art. The preferred techniques of obtaining a pregelatinized starch are techniques of cooking/drying starch suspensions in an aqueous medium such as, notably, atomization, drum cooking or extrusion. Autoclaving or indirect heating using a heat exchanger are also possible cooking methods and tend to produce complex colloidal dispersals consisting of intact, fragmented and swollen granules. Example methods for preparing such starches can be found in documents U.S. Pat. Nos. 3,086,890, 3,607,394 or else FR 2 822 471.

Preferably, said pregelatinized starch originates from a waxy starch, i.e rich in amylopectin and poor in amylose. It may in particular be a waxy starch from corn, potato or rice, preferentially waxy corn.

Said pregelatinized starch may or may not be modified before or after applying the cooking/drying treatment described hereinabove. In terms of modification, it may involve one or more modification(s) by physical means, physico-chemical means, chemical means or enzymatic means. It may in particular be a dextrinization, acid or enzymatic hydrolysis, carboxymethylation, hydroxypropylation, hydroxyethylation, acetylation, octenylsuccinylation, cationization, reticulation, grafting treatment. Preferably, the pregelatinized starch is selected from modified starches, notably dextrinized, hydrolyzed, carboxymethylated, hydroxypropylated, acetylated, octenylsuccinate or cationic, pregelatinized. More preferentially, the pregelatinized starch is selected from carboxymethylated, hydroxypropylated, acetylated, octenylsuccinate, pregelatinized starches.

Preferably, the pregelatinized starch according to the invention is obtained from a waxy corn starch and has undergone a chemical acetylation modification.

In particular, non-ionic pregelatinized starches are preferred and notably those from the range marketed by the Applicant under the brand name PREGEFLO®. Examples of such most preferred starches are, for example, PREGEFLO® CH 40.

In the present application, “non-starch polysaccharide” is understood to mean the polymers belonging to the family of carbohydrates with the exception of starches, amylose, amylopectin and mixtures thereof. The monosaccharides constituting said “non-starch polysaccharides” do not exclusively contain glucose and the glycosidic bonds are not exclusively alpha 1,4 and/or alpha 1,6 bonds. Without limitation, such non-starch polysaccharides are, for example, pectins, xanthan gums, alginate or agar.

According to a preferred embodiment, the legume albumin according to the invention has an emulsifying activity greater than 600 ml of corn oil per gram of albumin, preferentially greater than 800 ml of corn oil per gram of albumin, even more preferentially greater than 1000 ml of corn oil per gram of albumin.

Preferably, the legume albumin according to the invention is a pea albumin.

“Emulsifying activity” is defined as the maximum amount of oil that can be dispersed in an aqueous solution containing a defined amount of emulsifier before the emulsion breaks or reverses phase (Sherman, 1995). In order to quantify it, the Applicant has developed a test to quantify it easily, quickly and reproducibly.
0.2 g of the product sample is dispersed in 20 mL of water
The solution is homogenized with an Ultraturax IKA T25 for 30 seconds at a speed of 9,500 rpm
20 mL of corn oil is added under homogenization under the same conditions as step 2 above.
Centrifugation for 5 minutes at 3,100 g
   If a good emulsion is obtained, the test is repeated at point 1, increasing the quantities of water and corn oil by 50%.
   If a bad emulsion is obtained (phase shift), the test is repeated at point 1 reducing the quantities of water and corn oil by 50%.
The maximum amount of oil (Qmax in mL) that can be emulsified is thus determined iteratively.
The emulsifying capacity is therefore the maximum amount of corn oil that can be emulsified per gram of product.
   Emulsifying capacity=(Qmax/0.2)*100

Preferably, the protein content of the albumin is greater than 70%, preferentially greater than 80%, even more preferentially comprised between 80% and 90%, the optimum being comprised between 82% and 88%. Said content is calculated in relation to the solids. The protein content is obtained by any method well known to a person skilled in the art, and in particular by measuring the nitrogen content (by the Dumas or Kjeldahl method) and by multiplying it by the coefficient of 6.25.

Preferably, the solids of the albumin are greater than 80%, preferentially greater than 85%, even more preferentially greater than 90%, the optimum being comprised between 95% and 98%.

A particularly suitable method for extracting and producing said pea albumin is disclosed in the Applicant's patent application EP3614856 incorporated by reference in the present application. This method consists of a series of steps making it possible to remove starches, internal fibers and globulins from the pea flour. The soluble fraction thus obtained will undergo centrifugation or microfiltration. The supernatant or permeate will then be ultra-filtered in order to concentrate the high molecular weight albumins (PA2) in the retentate (salts, sugars and low molecular weight albumins of type Pal b can be found in the permeate). The pH of the retentate is then adjusted between 6.5 and 7.5, then it is subjected to a thermal treatment comprised between 130° C. and 150° C., preferentially 140° C., with a treatment time comprised between 5 and 15 seconds, preferentially 10 seconds.

Preferably, the composition according to the invention consists of a legume albumin and a pregelatinized starch in a respective weight ratio comprised between 0.9:0.1 and 0.6:0.4, preferentially comprised between 0.8:0.2 and 0.7:0.3, even more preferentially 0.75:0.25. Advantageously, this composition only contains these two compounds.

The invention also relates to a method for the production of the composition according to the invention comprising the following steps:
Provision of a legume albumin,
Provision of a pregelatinized starch
Mixture of said two compounds.

The first step consists in the provision of a legume albumin. According to a preferred embodiment, the legume albumin is selected from a list comprising peas and faba beans, preferably peas.

Any commercial source is possible, as well as any production resulting from the implementation of a public teaching e.g. an article or a patent. The methods described in patent applications EP1400537 and EP3614856 are particularly suitable.

Albumin can be provided in liquid or solid form, indiscriminately. It is necessary to have a product compatible with the requirements of the food and/or pharmaceutical industry.

The second step consists in the provision of a pregelatinized starch.

Any commercial source is possible, as well as any production resulting from the implementation of a public teaching e.g. an article or a patent. A particular method consists in extracting a waxy corn starch, by subjecting it to an acetylation reaction then passing the modified waxy starch through a drying drum in order to pregelatinize it. Commercial starches CLEARAM CH 40® manufactured by the company ROQUETTE are particularly suitable.

The third step consists of a mixture of the two compounds, albumin and starch. According to a particular embodiment, this mixture involves the addition of compounds other than legume albumin and pregelatinized starch. These compounds can be, without limitation, colorants, notably beta-carotene, flavorings or flavor modifiers, pH agents, in particular buffers or reagents, lipids.

The mixing is carried out using facilities well known to a person skilled in the art, in particular vat rooms, pumps, stirrers, scales. The facility is selected depending on whether the compounds are in solid or liquid form.

In the context of solid products, equipment is required allowing homogenization of the powders, such as a drum mixer, convective mixer, fluidized bed mixer or static mixer.

In the context of liquid products, a vat room equipped with a stirrer is satisfactory. However, the use of a homogenizer as well as a heating system is possible.

According to a particular embodiment, the third step of the method according to the invention is performed in a liquid medium, after rehydrating the albumin for less than or equal to 15 minutes. Preferably, the albumin is rehydrated before mixing with food-grade water, e.g. decarbonated, tap, demineralized, or distilled water. Surprisingly compared to the prior art (pea globulins used in examples 7, 8 and 9 of patent application WO2013067453), the rehydration time is considerably shorter, of the order of 15 minutes, while having a maximum effect.

According to a particular embodiment, the method according to the invention comprises a final additional step of treating the composition obtained, notably for the purposes of the use and/or marketing thereof.

By way of example treatments of this additional step, the composition can be concentrated, dried, or sterilized for the purposes of being stored and/or sold.

The composition can also be used directly in any composition for industrial application, preferentially food.

Finally the invention also relates to the use of the composition according to the invention comprising a legume albumin and a pregelatinized starch, in the field of human food or animal feed.

According to a preferred embodiment, the use according to the invention is made in applications by substituting egg, preferentially egg yolk.

More particularly, the invention relates to the use of the composition according to the invention in nutritional formulations such as:
beverages, particularly via mixtures of powders to be reconstituted, particularly for dietary nutrition (sports, slimming), ready-to-drink beverages for dietary or clinical nutrition, liquids for clinical nutrition such as enteral beverages or bags, vegetable beverages,
yogurt-type fermented milks, such as blended, Greek or drinkable yogurts,
plant creams, such as coffee creamer or whitener, dessert creams, frozen desserts or sorbets.
biscuits, muffins, pancakes, nutritional bars, particularly intended for specialized nutrition for slimming or for athletes, bread, particularly high-protein gluten-free bread, high-protein cereals, obtained by extrusion cooking (“crisps” for inclusion, breakfast cereals, snacks),
cheese,
meat analogues, fish analogues,
sauces, in particular mayonnaise.

According to a particular embodiment, the use according to the invention relates to vegan mayonnaise recipes, with the total absence of compounds originating from eggs or milk.

“Vegan” is understood to mean being free from animal products.

The invention will be better understood by means of the following non-limiting examples.

### EXAMPLES

### Example 1: Preparation of a Pea Albumin

The first step is to obtain the soluble fraction of the pea. Pea flour is initially prepared by grinding dehulled field peas on an ALPINE hammer mill equipped with a 100 pm grid. 300 kg of flour with a solids content of 87% are then soaked in water at a final concentration of 25% on a dry weight basis, at a pH of 6.5. 1044 kg of flour suspension containing 25% by weight of solids (thus 261 kg of dry flour) are then introduced with 500 kg of water into a hydrocyclone array formed of 14 stages. It is fed the flour suspension on stage No. 5. This separation leads to the obtaining of a light phase which corresponds to the output of stage No 1. It consists of a mixture of proteins and internal and soluble fibers.

This light phase at the hydrocyclone outlet contains as a mixture (142 kg of solids in total): the fibers (about 14.8% by weight, that is 21 kg of solids), the proteins (about 42.8% by weight, that is 60.8 kg of solids) and soluble matter (about 42.4% by weight, that is 60.2 kg of solids). This fraction has 11.4% solids. The fibers are separated out on WESTFALIA decanter centrifuges used in an industrial potato starch processing unit. The light phase at the outlet of the centrifugal decanter contains a mixture of proteins and of soluble matter, while the heavy phase contains the pea fibers. The heavy phase contains 105 kg of fibers with a solids content of 20%. It is noted that virtually all of the fibers are indeed found in this fraction.

The protein-and-solubles fraction contains 1142 kg of a dissolved mixture of soluble matter and proteins (6% solids fraction). The proteins are flocculated at their isoelectric point by adjusting the light phase at the outlet of the decanter centrifuge to a pH of 4.5 and heating to 50° C.

The flocculated proteins are left for 10 minutes in the maturation tank. After protein precipitation, centrifugal decantation is performed, which makes it possible to recover, after drying, the sediment containing 56 kg of globulin type proteins (86% of N×6.25 on a dry basis) with 93% solids and a soluble fraction containing albumins, sugars and salts, titrating 2.5 g per 100 g in solids including 27% proteins.

The soluble pea fraction thus obtained is firstly degassed by passing through an SPX DEROX module. The control parameters of said SPX DEROX module are the following:

TABLE 1

| | | |
|---|---|---|
| Supply pressure | bar | 0.88 |
| Outlet pressure | bar | 2.73 |
| Supply T ° C. | ° C. | 50.5 |
| Outlet T ° C. | ° C. | 42.8 |
| Condenser T ° C. | ° C. | 37 |
| Vacuum setpoint | bar | 0.1 |
| Tank level setpoint | % | 60 |
| Withdrawal rate to NA7 | L/H | 750 |
| Dissolved inlet O₂ | mg/L | 9 |
| Dissolved outlet O₂ | mg/L | 0.1 |

Correct degassing is controlled by measuring the dissolved oxygen at the inlet and outlet.

Then, this degassed soluble pea fraction is pumped through a microfiltration unit equipped with Inside Ceram® type ceramic membranes with a cut-off of 0.14 μm (19 channels of 4.5 mm). Throughout the filtration process, the temperature is regulated at 60° C. and the transmembrane pressure is maintained at a value between 0.4 and 0.6 bar.

The permeate is pumped through an ultrafiltration unit. The ultrafiltration unit is equipped with ceramic membranes of the KERASEP® BX type marketed by the company NOVASEP and having a cut-off of 15 kDa (7 channels each 6 mm). Throughout the filtration process, the temperature is regulated at 60° C. and the transmembrane pressure is maintained at a value between 1 and 3 bar.

3 successive diafiltrations are performed, consisting of performing 3 repetitions of adding a volume of decarbonated drinking water to a volume of retentate followed by ultrafiltration until solids of the permeate less than 0.5% of solids is obtained.

The ultrafiltration permeate obtained is then rectified, under stirring, to pH 6.8 by adding 50% sodium hydroxide solution.

UHT thermal treatment is then applied to the neutralized ultrafiltration permeate consisting of a passage through a VOMATEC module, at a temperature of 140° C. for a contact time of about ten seconds then subjected to flash evaporation under a vacuum at approximately 90° C.

The solution obtained at the outlet of the UHT thermal treatment is finally sprayed in a single-effect sprayer type spray tower. The inlet temperature setpoint is 190° C. and the outlet temperature between 85 and 90° C.

The pea albumin powder obtained is called “pea albumin”. The composition thereof is given in the table below:

TABLE 2

| | | |
|---|---|---|
| Solids content | 94.4 | % |
| Protein content (N × 6.25) | 94 | g/100 g of solids |
| Ash content | 2.5 | g/100 g of solids |
| Emulsifying activity | 1314 | ml of corn oil by g of protein |

### Example 2: Preparation of Classic Mayonnaise (Egg Yolk) and with Compositions According to the Prior Art and According to the Invention

The following ingredients will be used, among others:
pea albumin prepared according to example 1
pea globulin NUTRALYS® F85F (ROQUETTE company)
an acetylated and pregelatinized waxy corn based starch PREGEFLO® CH40 (ROQUETTE company)

The formulations of the mayonnaises are as follows:

TABLE 3

| | |
|---|---|
| | Classic egg |
| Vegan mayonnaise (egg-free) | mayonnaise |

Ingredients for Phase 1

| | | | | |
|---|---|---|---|---|
| Water | 10.58 | g | 10.58 | g |

| Composition according | 0.8 g of pea albumin and 0.25 g of | | |
|---|---|---|---|
| to the invention | PREGEFLO ® CH40 | | |
| Composition according | 0.52 g of NUTRALYS ®F85F and | | |
| to the prior art 1 | 0.52 g of PREGEFLO ® CH40 | | |
| Composition according | 0.52 g of pea albumin and 0.52 g | | |
| to the prior art 2 | of PREGEFLO ® CH40 | | |
| Egg yolk | | 5 | g |

Ingredients of Phase 2

| | |
|---|---|
| Mustard | 2.5 g |
| Sucrose | 4.5 g |
| Sodium chloride | 1 g |
| Potassium sorbate | 0.12 g |

Ingredients for Phase 3

| | | | | |
|---|---|---|---|---|
| Sunflower oil | 70 | g | 65.8 | g |

Ingredients for Phase 4

| | |
|---|---|
| Vinegar | 5.5 g |
| Lemon juice | 2.5 g |

Ingredients for Phase 5

| | |
|---|---|
| Sunflower oil | 2.5 g |

The preparation protocol using a HOTMIX Pro mixer (marketed by Vitaeco S.R.L.) is as follows:
Phase 1: in the HOTMIX Pro bowl, hydrate the compositions with water for a set time, at speed 3 (i.e. 800 rpm)
Phase 2: Add mustard, sucrose, sodium chloride and potassium sorbate and mix for 1 minute still at speed 3
Phase 3: pour a thin trickle of oil, continuously, for approximately 2 minutes at speed 3
Phase 4: add vinegar and lemon juice, still at speed 3
Phase 5: End by adding the rest of the oil, still at speed 3
Finish by stirring at speed 3 for 1 minute

For phase 1, the protein rehydration time is 15 minutes.

### Example 3: Comparison of Different Compositions in a Mayonnaise

The mayonnaises are compared with the following analyses
Size and stability of the emulsion using a MALVERN Mastersizer 3000 laser particle size analyzer. The product is dispersed in the reverse osmosis water in the laser particle size analyzer bowl and stirred at 1,900 rpm. The analysis is performed after one day. The analysis parameters are: obscuration between 5% and 10%, optical model at 1.4+0.01i, 3 averaged measurements. The Dmode values are obtained; D4.3, D3.2 D90, D10 and D50. D3.2 is an excellent indicator of emulsion stability: the smaller the number, the more stable the emulsion.
Texture of the emulsion. The device used is the TAXT2 Texture Analyzer by the company STABLE MICRO SYSTEMS LTD. It will be equipped with the “Back extrusion RIG 45 mm DISC”. The following parameters are used: compression mode, pre-test speed 1 mm/sec, test speed 1 mm/sec, post-test speed 10 mm/sec, distance target mode, distance 30 mm, auto type trigger, trigger force 10 G, off mode. A measurement of the force (in G) required to penetrate the mayonnaise is obtained: the higher this measurement, the firmer the mayonnaise.

The results obtained are as follows

TABLE 4

| | Force | D3.2 |
|---|---|---|
| | (in g) | (in microns) |
| Mayonnaise according to the invention | 707.2 | 4.25 |
| Mayonnaise according to prior art 1 | 488.7 | 27.5 |
| (use of globulin) | | |
| Mayonnaise according to prior art 2 | 585.2 | 2.76 |
| (protein/starch ratio by weight of 0.5:0.5) | | |
| AMORA commercial mayonnaise | 741.8 | 6.22 |

These results show that only the invention has:
A firmness in G greater than 700, and therefore similar to egg mayonnaise
And a stability of the emulsion thereof of less than 10 microns

It is the combination of the choice of protein, a pea albumin, and the ratio used that makes it possible to obtain these unique results.

The composition according to the invention offers an undeniable advantage by obtaining an identical result to egg yolk, and limiting the rehydration phase to 15 minutes.

1. A composition comprising a legume albumin and a pregelatinized starch in a respective weight ratio comprised between 0.9:0.1 and 0.6:0.4, preferentially comprised between 0.8:0.2 and 0.7:0.3, even more preferentially 0.75:0.25, and not comprising any non-starch polysaccharide.

2. The composition according to claim 1, wherein the legume is selected from a list comprising peas and faba beans.

3. The composition according to claim 1, wherein the legume is a pea plant.

4. The composition according to claim 1, wherein the albumin has an emulsifying activity greater than 600 ml of corn oil per gram of albumin, preferentially greater than 800 ml of corn oil per gram of albumin, even more preferentially greater than 1000 ml of corn oil per gram of albumin

5. The composition according to claim 1, wherein the pregelatinized starch is obtained from a waxy corn starch and has undergone a chemical acetylation modification

6. A method for producing the composition according to claim 1 comprising the following steps:
1. provision of a legume albumin;
2. provision of a pregelatinized starch; and
3. mixture of the two compounds.

7. The method according to claim 6, wherein the legume is selected from a list comprising peas and faba beans.

8. The method according to claim 6, wherein the legume is a pea plant.

9. The method according to claim 6 wherein step three is carried out in a liquid medium, after the albumin has been rehydrated for a time less than or equal to 15 minutes.

10. The method according to claim 6 wherein the mixture of step 3 involves adding compounds other than legume albumin and pregelatinized starch.

11. The method according to claim 6 comprising a final additional step of treating the composition obtained.

12. The use of the composition according to claim 1, in the field of human food or animal feed.

13. The use according to claim 12 in the egg substitution applications, preferentially in egg yolk substitution applications.

14. The use according to claim 12 in:
beverages, in particular beverages for dietary or clinical nutrition, enteral beverages or bags, plant beverages,
fermented milks such as yogurts,
plant creams,
dessert creams,
frozen desserts or sorbets,
biscuits, muffins, pancakes,
nutritional bars for dietetic nutrition
breads,
high-protein cereals,
cheeses,
meat analogues,
fish analogues,
sauces, in particular mayonnaise.

15. The use according to claim 12 in vegan mayonnaise recipes, with the total absence of compounds originating from eggs or milk.
